(19) United States
(12) Patent Application Publication
(10) Pub. No.: US 2023/0023374 A1
(43) Pub. Date: Jan. 26, 2023

(54) METHOD FOR CALIBRATING MONTHLY PRECIPITATION FORECAST BY USING GAMMA-GAUSSIAN DISTRIBUTION

(71) Applicant: SUN YAT-SEN UNIVERSITY, Guangdong (CN)

(72) Inventors: Tongtiegang ZHAO, Guangdong (CN); Zeqing HUANG, Guangdong (CN)

(73) Assignee: SUN YAT-SEN UNIVERSITY, Guangdong (CN)

(21) Appl. No.: 17/948,240

(22) Filed: Sep. 20, 2022

Related U.S. Application Data
(63) Continuation of application No. PCT/CN2020/130457, filed on Nov. 20, 2020.

(30) Foreign Application Priority Data
Nov. 19, 2020 (CN) 202011303631.2

(51) Int. Cl. G01W 1/10; G06F 17/18

(52) U.S. Cl. CPC G01W 1/10; G06F 17/18

(57) ABSTRACT

The present invention provides a method for calibrating monthly precipitation forecast by using a Gamma-Gaussian distribution, including the following steps: acquiring forecast data of monthly average precipitation in a watershed area and corresponding observed values of the average precipitation in the watershed area as input data; performing fitting on the input data by means of a Gamma distribution function; calculating a cumulative distribution function value of each input data in a corresponding Gamma distribution; transforming the cumulative distribution function values into variables obeying a standard normal distribution; constructing a joint normal distribution according to the variables obeying the standard normal distribution to characterize a correlation between the forecast data and the observed values in the input data; and randomly sampling the observed values according to the correlation, and inversely transforming acquired samples to obtain a calibrated forecast result.

### CROSS-REFERENCE TO RELATED APPLICATION

This application is a continuation of international application of PCT application serial no. PCT/CN2020/130457, filed on Nov. 20, 2020, which claims the priority benefit of China application no. 202011303631.2 filed on Nov. 19, 2020. The entirety of each of the above-mentioned patent applications is hereby incorporated by reference herein and made a part of this specification.

### TECHNICAL FIELD

The present invention relates to the field of hydrologic forecast, and more particularly to a method for calibrating monthly precipitation forecast by using a Gamma-Gaussian distribution.

### BACKGROUND

An existing global climate model can provide abundant precipitation forecast information. A monthly precipitation forecast of a basin extracted from a global precipitation forecast product can provide important reference for reservoir scheduling, agricultural irrigation, flood control, and drought fight in the basin. Monthly raw forecast data and observed data have a good correlation therebetween. However, the system is complex and has a random error, which brings difficulties to the practical application of the precipitation forecast, and affects the forecast skill to a certain extent.

The patent publication No. CN108830419A (publication date: Nov. 16, 2018) provides a joint forecast method for inflow flows of cascaded reservoir group based on ECC post-processing, relates to the technical field of hydrologic forecast, and discloses: a systematic error of ensemble numerical weather forecast data is calibrated on the basis of measured data and a Gamma distribution function. However, the method of the patent still has a random error, and still has a certain impact on the forecast skill.

### SUMMARY

In order to overcome the defect in the prior art that the system complexity and the random error affect the precipitation forecast skill, the present invention provides a method for calibrating monthly precipitation forecast by using a Gamma-Gaussian distribution.

In order to solve the above technical problem, the technical solution of the present invention is as follows:

A method for calibrating monthly precipitation forecast by using a Gamma-Gaussian distribution, including the following steps:

S1, acquiring forecast data of monthly average precipitation in a watershed area and corresponding observed values of the average precipitation in the watershed area as input data;

S2, performing fitting on the input data by means of a Gamma distribution function;

S3, calculating a cumulative distribution function value of each input data in a corresponding Gamma distribution;

S4, transforming the cumulative distribution function values into variables obeying a standard normal distribution;

S5, constructing a joint normal distribution according to the variables obeying the standard normal distribution to characterize a correlation between the forecast data and the observed values in the input data; and

S6, randomly sampling the observed values according to the correlation, and inversely transforming acquired samples to obtain a calibrated forecast result.

Preferably, in the step S2, the Gamma distribution function is used to perform fitting on the forecast data and the observed values respectively to obtain marginal distributions of the raw forecast data and the observed values; the expression formula thereof is as follows:

$$\{ \begin{matrix}F \sim G ( {α}_{f} , {β}_{f} ) \\ O \sim G ( {α}_{o} , {β}_{o} )\end{matrix}$$

Wherein F denotes a set of K acquired forecast data [f₁, f₂, . . . , f_{K}]; O denotes a set of K acquired observed values [o₁, o₂, . . . , o_{K}]; G(*) denotes the Gamma distribution function; α_{f} and β_{f} denote Gamma distribution parameters of the forecast data obtained by means of fitting; and αₒ and βₒ denote Gamma distribution parameters of the observed values obtained by means of fitting.

Preferably, the Gamma distribution parameters α_{f}, β_{f}, αₒ, and βₒ are respectively calculated with a maximum likelihood estimation method.

Preferably, in the step S3, a cumulative distribution function in the corresponding Gamma distribution is used to calculate the cumulative distribution function values of each forecast data fᵢ and of each observed value oᵢ in the corresponding Gamma distribution; the expression formula thereof is as follows:

$$\{ \begin{matrix}{P}_{{f}_{i}} = {CDF}_{( {α}_{F} , {β}_{F} )} ( {f}_{i} ) \\ {P}_{{o}_{i}} = {CDF}_{( {α}_{O} , {β}_{O} )} ( {o}_{i} )\end{matrix}$$

Wherein P_{f}_{ᵢ} and Pₒ_{ᵢ} respectively denote the cumulative distribution function values corresponding to the forecast data fᵢ and the observed values oᵢ in an i-th year; and CDF_{(α}_{_{F}}_{,β}_{_{F}}₎(fᵢ) and CDF_{(α}_{ₒ}_{,β}_{ₒ}₎(oᵢ) respectively denote the cumulative distribution functions in the Gamma distribution obtained by performing fitting on the forecast data fᵢ and the observed values oᵢ.

Preferably, in the step S4, the cumulative distribution function values are regarded as quantiles of the standard normal distribution; the cumulative distribution function values are transformed into variables obeying the standard normal distribution by means of an inverse function of the cumulative distribution function in the standard normal distribution; and the expression formula thereof is as follows:

$$\{ \begin{matrix}{\hat{f}}_{i} = {PPF}_{N ( 0 , {1}^{2} )} ( {P}_{{f}_{i}} ) \\ {\hat{o}}_{i} = {PPF}_{N ( 0 , {1}^{2} )} ( {P}_{{o}_{i}} )\end{matrix}$$

Wherein PPF_{N(0,1}_{²⁾}(⋅) denotes the inverse function of the cumulative distribution function in the standard normal distribution; and \hat{f}ᵢ and ôᵢ are respectively the forecast data and the observed values obtained by means of normal quantile transform. The transformed forecast data \hat{F}=[\hat{f}₁, \hat{f}₂, . . . , \hat{f}f_{K}] and the transformed observed values Ô=[ô₁, ô₂, . . . , ô_{K}] all obey normal distributions, and the expression formula thereof is as follows:

$$\{ \begin{matrix}\hat{F} \sim N ( 0 , {1}^{2} ) \\ \hat{O} \sim N ( 0 , {1}^{2} )\end{matrix}$$

Wherein N(0,1²) denotes a standard normal distribution.

Preferably, in the step S5, a joint normal distribution is constructed according to the variables \hat{F} and Ô obeying the standard normal distribution to characterize the correlation between the forecast data and the observed values in the input data; and the expression formula thereof is as follows:

$$[ \begin{matrix}\hat{F} \\ \hat{O}\end{matrix} ] \sim N ( [ \begin{matrix}0 \\ 0\end{matrix} ] , [ \begin{matrix}1 & ρ \\ ρ & 1\end{matrix} ] )$$

Wherein ρ denotes the correlation between the variables \hat{F} and Ô.

Preferably, in the step S6, the specific steps are as follows:

S6.1, taking the forecast data \hat{f} as a predictor, taking the observed value Ô corresponding to each forecast data as a predictand, and calculating a conditional probability distribution of the predictand, wherein the calculation formula is as follows:

ô|\hat{f}˜N(ρ\hat{f},1−ρ²)

S6.2, randomly sampling the conditional probability distribution result of the observed value Ô, and inversely transforming sampled samples according to the cumulative distribution function in the standard normal distribution and the inverse function of the cumulative distribution function in the Gamma distribution obtained by performing fitting on the observed value, so as to obtain a calibrated forecast result.

Preferably, the method further includes the following step: calculating a bias value and forecast skill according to the calibrated forecast result as forecast verification metrics.

Preferably, the method further includes the following step: drawing a forecast diagnostic diagram according to the calibrated forecast result, the bias value, and the forecast skill.

Preferably, in the forecast diagnostic diagram, a calibrated forecast median is used as the x axis; a precipitation forecast distribution interval and the observed values are used as the y axis; and the calculation results of the bias value and the forecast skill are inserted in the forecast diagnostic diagram for display.

Compared with the prior art, the beneficial effects of the technical solution of the present invention are: the present invention transforms the precipitation forecast and the observed data into normal distributions by means of the Gamma distribution, thereby avoiding the complex data normalization method; furthermore, the present invention constructs a joint normal distribution according to the variables obeying the standard normal distribution to characterize the correlation between the forecast data and the observed values in the input data, and further randomly samples the observed values according to the correlation, thereby effectively quantifying the random error, solving the problem that the system complexity and the random error affect the precipitation forecast skill, and effectively improving the forecast skill.

### BRIEF DESCRIPTION OF DRAWINGS

FIG. 1 is a flow chart of the method for calibrating monthly precipitation forecast by using a Gamma-Gaussian distribution according to an embodiment 1;

FIG. 2 shows input data in tables according to an embodiment 2;

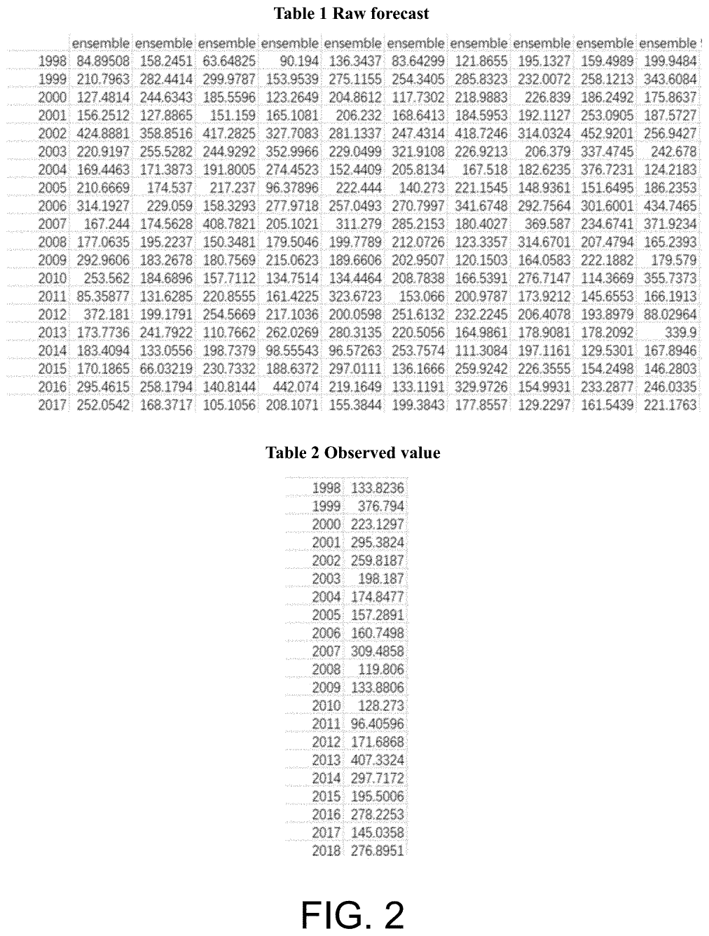

FIG. 3 is a quantile-quantile plot of observed precipitation values before transformation according to the embodiment 2;

FIG. 4 is a quantile-quantile plot of observed precipitation values after transformation according to the embodiment 2;

FIG. 5 is a time series diagram of raw forecast data according to the embodiment 2;

FIG. 6 is a time series diagram of calibrated forecast according to the embodiment 2;

FIG. 7 is a diagnostic diagram of the raw forecast according to the embodiment 2; and

FIG. 8 is a diagnostic diagram of the calibrated forecast according to the embodiment 2.

### DETAILED DESCRIPTION OF EMBODIMENTS

The drawings are used for illustrative purpose only, but should not be considered as a limitation to the present patent.

For a person skilled in the art, it is understandable that certain commonly known structures in the figures and the descriptions thereof can be omitted.

The technical solution of the present invention will be further described below with reference to the accompanying drawings and embodiments.

### Embodiment 1

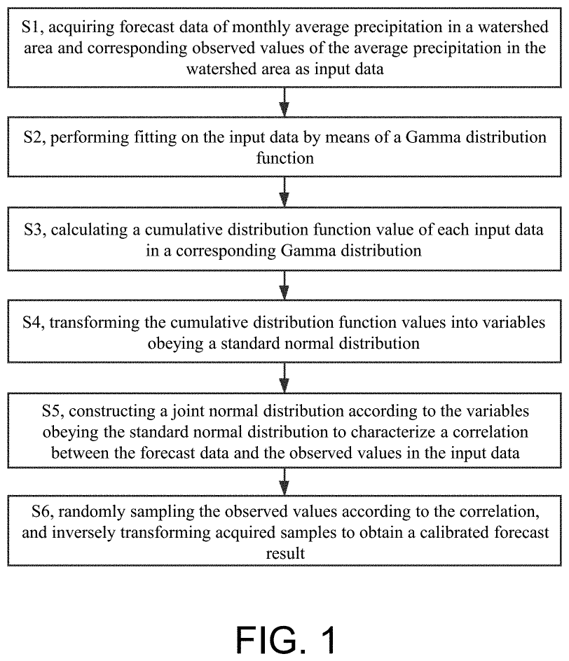

The present embodiment provides a method for calibrating monthly precipitation forecast by using a Gamma-Gaussian distribution. FIG. 1 shows a flow chart of the method for calibrating monthly precipitation forecast by using a Gamma-Gaussian distribution according to the present embodiment.

The method for calibrating monthly precipitation forecast by using a Gamma-Gaussian distribution provided by the present embodiment includes the following steps:

S1, acquiring forecast data of monthly average precipitation in a watershed area and corresponding observed values of the average precipitation in the watershed area as input data.

S2, performing fitting on the input data by means of a Gamma distribution function.

Specifically, the Gamma distribution function is used to perform fitting on the forecast data and the observed values respectively to obtain marginal distributions of the raw forecast data and the observed values; the expression formula thereof is as follows:

$$\{ \begin{matrix}F \sim G ( {α}_{f} , {β}_{f} ) \\ O \sim G ( {α}_{o} , {β}_{o} )\end{matrix}$$

Wherein F denotes a set of K acquired forecast data [f₁, f₂, . . . , f_{K}]; O denotes a set of K acquired observed values [o₁, o₂, . . . , o_{K}]; G(⋅) denotes the Gamma distribution function; α_{f} and β_{f} denote Gamma distribution parameters of the forecast data obtained by means of fitting; and αₒ and βₒ denote Gamma distribution parameters of the observed values obtained by means of fitting.

Wherein the Gamma distribution parameters α_{f}, β_{f}, αₒ, and βₒ are respectively calculated with a maximum likelihood estimation method.

S3, calculating a cumulative distribution function value of each input data in a corresponding Gamma distribution.

Specifically, a cumulative distribution function in the corresponding Gamma distribution is used to calculate the cumulative distribution function value of each forecast data fᵢ and of each observed value oᵢ in the corresponding Gamma distribution; the expression formula thereof is as follows:

$$\{ \begin{matrix}{P}_{{f}_{i}} = {CDF}_{( {α}_{F} , {β}_{F} )} ( {f}_{i} ) \\ {P}_{{o}_{i}} = {CDF}_{( {α}_{O} , {β}_{O} )} ( {o}_{i} )\end{matrix}$$

Wherein P_{f}_{ᵢ} and Pₒ_{ᵢ} respectively denote the cumulative distribution function values corresponding to the forecast data fᵢ and the observed values oᵢ in an i-th year; and CDF_{(α}_{_{F}}_{,β}_{_{F}}₎(fᵢ) and CDF_{(α}_{ₒ}_{,β}_{ₒ}₎(oᵢ) respectively denote the cumulative distribution functions in the Gamma distribution obtained by performing fitting on the forecast data fᵢ and the observed values oᵢ.

S4, transforming the cumulative distribution function values into variables obeying a standard normal distribution.

Specifically, the cumulative distribution function values are regarded as quantiles of the standard normal distribution; the cumulative distribution function values are transformed into variables obeying the standard normal distribution by means of an inverse function of the cumulative distribution function in the standard normal distribution; and the expression formula thereof is as follows:

$$\{ \begin{matrix}{\hat{f}}_{i} = {PPF}_{N ( 0 , {1}^{2} )} ( {P}_{{f}_{i}} ) \\ {\hat{o}}_{i} = {PPF}_{N ( 0 , {1}^{2} )} ( {P}_{{o}_{i}} )\end{matrix}$$

Wherein PPF_{N(0,1}_{²⁾}(⋅) denotes the inverse function of the cumulative distribution function in the standard normal distribution; and \hat{f}ᵢ and ôᵢ are respectively the forecast data and the observed values obtained by means of normal quantile transform. The transformed forecast data \hat{F}=[\hat{f}₁, \hat{f}₂, . . . , \hat{f}_{K}] and the transformed observed values Ô=[ô₁,ô₂, . . . , ô_{K}] all obey normal distributions, and the expression formula thereof is as follows:

$$\{ \begin{matrix}\hat{F} \sim N ( 0 , {1}^{2} ) \\ \hat{O} \sim N ( 0 , {1}^{2} )\end{matrix}$$

Wherein N(0,1²) denotes a standard normal distribution.

S5, constructing a joint normal distribution according to the variables obeying the standard normal distribution to characterize a correlation between the forecast data and the observed values in the input data.

Specifically, a joint normal distribution is constructed according to the variables \hat{F} and Ô obeying the standard normal distribution to characterize the correlation between the forecast data and the observed values in the input data; and the expression formula thereof is as follows:

$$[ \begin{matrix}\hat{F} \\ \hat{O}\end{matrix} ] \sim N ( [ \begin{matrix}0 \\ 0\end{matrix} ] , [ \begin{matrix}1 & ρ \\ ρ & 1\end{matrix} ] )$$

Wherein ρ denotes the correlation between the variables \hat{F} and Ô.

S6, randomly sampling the observed values according to the correlation, and inversely transforming acquired samples to obtain a calibrated forecast result. The specific steps thereof are as follows:

S6.1, taking the forecast data \hat{f} as a predictor, taking the observed value Ô corresponding to each forecast data as a predictand, and calculating a conditional probability distribution of the predictand, wherein the calculation formula is as follows:

ô|\hat{f}˜N(ρ\hat{f},1−ρ²);

S6.2, randomly sampling the conditional probability distribution result of the observed value Ô, and inversely transforming sampled samples according to the cumulative distribution function in the standard normal distribution and the inverse function of the cumulative distribution function in the Gamma distribution obtained by performing fitting on the observed value, so as to obtain a calibrated forecast result.

Further, the method further includes the following steps: calculating a bias value and forecast skill according to the calibrated forecast result as forecast verification metrics; and drawing a forecast diagnostic diagram according to the calibrated forecast result, the bias value, and the forecast skill.

Wherein in the forecast diagnostic diagram, a calibrated forecast median is used as the x axis; a precipitation forecast distribution interval and the observed values are used as the y axis; and the calculation results of the bias value and the forecast skill are inserted in the forecast diagnostic diagram for display.

The method for calibrating monthly precipitation forecast by using a Gamma-Gaussian distribution provided by the present embodiment can be implemented on an open source language platform Python.

In a specific implementation process, a function read_csv of an open source third party library Pandas of Python is used to read the precipitation forecast and the observed data in a pre-stored file, so as to obtain the input data to be acquired in the step S1. Then, the mathematical calculation processes in the steps S2-S6 are programmed on the language platform Python mainly by using third party libraries Numpy and Scipy. The steps are encapsulated to form class functions in the class ( ) and def ( ) forms. And the class functions can be called to calibrate the precipitation forecast.

On the basis that the calibrated forecast is obtained, the forecast verification metrics such as the bias and the forecast skill CRPSS are calculated by means of Numpy, and then a forecast diagnostic diagram is drawn by means of a third party library Matplotlib of the Python, so as to compare and analyze the improvement effect of the calibrated forecast result in the present embodiment.

In the present embodiment, the precipitation forecast and the observed data are transformed into normal distributions by means of the Gamma distribution, thereby avoiding the complex data normalization method; furthermore, a joint normal distribution is constructed according to the variables obeying the standard normal distribution to characterize the correlation between the forecast data and the observed values in the input data, and the observed values are randomly sampled according to the correlation, thereby effectively quantifying the random error, solving the problem that the system complexity and the random error affect the precipitation forecast skill, and effectively improving the forecast skill.

### Embodiment 2

The present embodiment provides a specific implementation process. In such process, the method for calibrating monthly precipitation forecast by using a Gamma-Gaussian distribution provided by the embodiment 1 is used to calibrate, on the platform Python, the monthly precipitation forecast ECMWF-S2S of Beijiang in the Pearl River basin.

First, forecast data of monthly average precipitation in a watershed area and corresponding observed values of the average precipitation in the watershed area are acquired as input data; the input data of the present embodiment are stored in a csv file, as shown in table 1 and table 2.

TABLE 1
Raw forecast

| | ensemble | ensemble | ensemble | ensemble | ensemble | ensemble | ensemble | ensemble | ensemble | ensemble |
|---|---|---|---|---|---|---|---|---|---|---|
| 1998 | 84.89508 | 158.2451 | 63.64825 | 90.194 | 136.3437 | 83.64299 | 121.8655 | 195.1327 | 159.4989 | 199.9484 |
| 1999 | 210.7963 | 282.4414 | 299.9787 | 153.9599 | 275.1155 | 254.3405 | 285.8323 | 232.0072 | 258.1213 | 343.6084 |
| 2000 | 127.4814 | 244.6343 | 185.5596 | 123.2649 | 204.8612 | 117.7302 | 218.9883 | 225.839 | 186.2492 | 175.8637 |
| 2001 | 155.2512 | 127.8865 | 151.159 | 185.1081 | 206.232 | 168.6413 | 184.9953 | 192.1127 | 253.0905 | 187.5727 |
| 2002 | 424.8881 | 358.8516 | 417.2825 | 327.7083 | 281.1337 | 247.4314 | 418.7246 | 314.0324 | 452.9201 | 256.9427 |
| 2003 | 220.9197 | 255.5282 | 244.9292 | 352.9966 | 229.0499 | 321.9108 | 226.9213 | 206.379 | 337.4745 | 242.678 |
| 2004 | 169.4463 | 171.3873 | 191.8005 | 274.4523 | 152.4409 | 205.8134 | 187.518 | 182.6235 | 376.7231 | 124.2183 |
| 2005 | 210.6669 | 174.537 | 217.237 | 96.37896 | 222.444 | 140.273 | 221.1545 | 148.9361 | 151.6495 | 186.2353 |
| 2006 | 314.1927 | 229.059 | 158.3293 | 277.9718 | 257.0493 | 270.7997 | 341.6748 | 292.7564 | 301.6001 | 434.7465 |
| 2007 | 157.244 | 174.5628 | 408.7821 | 205.1021 | 311.279 | 285.2153 | 180.4027 | 369.587 | 234.6741 | 371.9234 |
| 2008 | 177.0635 | 195.2237 | 150.3481 | 179.5046 | 199.7789 | 212.0726 | 123.3357 | 314.6701 | 207.4794 | 165.2393 |
| 2009 | 292.9606 | 183.2678 | 180.7569 | 215.0623 | 189.6606 | 202.9507 | 120.1503 | 164.0583 | 222.1882 | 179.579 |
| 2010 | 253.562 | 184.6896 | 157.7112 | 134.7514 | 134.4464 | 208.7838 | 166.5391 | 276.7147 | 114.3669 | 355.7373 |
| 2011 | 85.35877 | 131.6285 | 220.3555 | 161.4225 | 323.5723 | 153.066 | 200.9787 | 173.9212 | 145.6553 | 166.1913 |
| 2012 | 372.181 | 199.1791 | 254.5669 | 217.1036 | 200.0598 | 251.6132 | 232.2245 | 206.4078 | 193.8979 | 88.02964 |
| 2013 | 173.7736 | 241.7922 | 110.7662 | 262.0269 | 280.3135 | 220.5056 | 164.9861 | 178.9081 | 178.2092 | 338.9 |
| 2014 | 183.4094 | 133.0556 | 193.7379 | 98.55543 | 96.57263 | 253.7574 | 111.3084 | 197.1161 | 128.5301 | 167.8946 |
| 2015 | 170.1865 | 66.03219 | 230.7332 | 188.6372 | 297.0111 | 136.1666 | 259.9242 | 226.3555 | 154.2498 | 146.2803 |
| 2016 | 295.4615 | 258.1794 | 140.8144 | 442.074 | 219.1649 | 133.1191 | 329.9726 | 154.9931 | 233.2877 | 246.0335 |
| 2017 | 252.0542 | 168.3717 | 105.1056 | 208.1071 | 155.3844 | 199.3643 | 177.8557 | 129.2297 | 151.5439 | 221.1763 |

TABLE 2
Observed value

| | |
|---|---|
| 1998 | 133.8236 |
| 1999 | 376.794 |
| 2000 | 223.1297 |
| 2001 | 295.3824 |
| 2002 | 259.8187 |
| 2003 | 198.187 |
| 2004 | 174.8477 |
| 2005 | 167.2891 |
| 2006 | 160.7498 |
| 2007 | 309.4858 |
| 2008 | 119.806 |
| 2009 | 133.8806 |
| 2010 | 128.273 |
| 2011 | 96.40596 |
| 2012 | 171.6868 |
| 2013 | 407.3324 |
| 2014 | 297.7172 |
| 2015 | 195.5005 |
| 2016 | 278.2253 |
| 2017 | 145.0358 |
| 2018 | 276.8951 |

Wherein the precipitation forecast data is cumulative precipitation amount in a thirty-day forecast period forecast at the beginning of January to December.

During implementation, the raw forecast data to be calibrated and the observed data are read by means of the function read_csv, and are respectively stored in the variables temp_x and temp_y.

A monthly precipitation forecast calibration model based on a Gamma-Gaussian distribution is constructed. The mathematical calculation processes in the steps S2-S6 in the embodiment 1 are executed mainly by means of the third party library Scipy, mainly including Gamma distribution fitting, joint normal distribution construction, and conditional probability distribution.

Specifically, a function stats.gamma.fit is used to respectively perform Gamma distribution fitting on mean value of the raw forecast data and the observed values; and the Gamma distribution parameters are obtained with the maximum likelihood estimation method, and are stored in the variables para_x and para_y.

A function stats.gamma.cdf is used to calculate the cumulative distribution function values of the raw forecast data and the observed data according to the fitted Gamma distribution parameters.

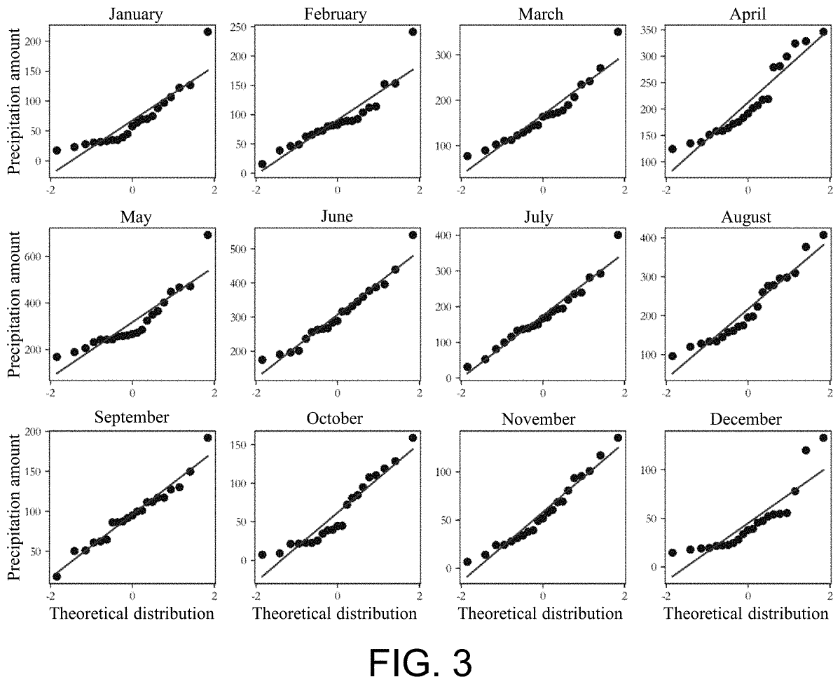

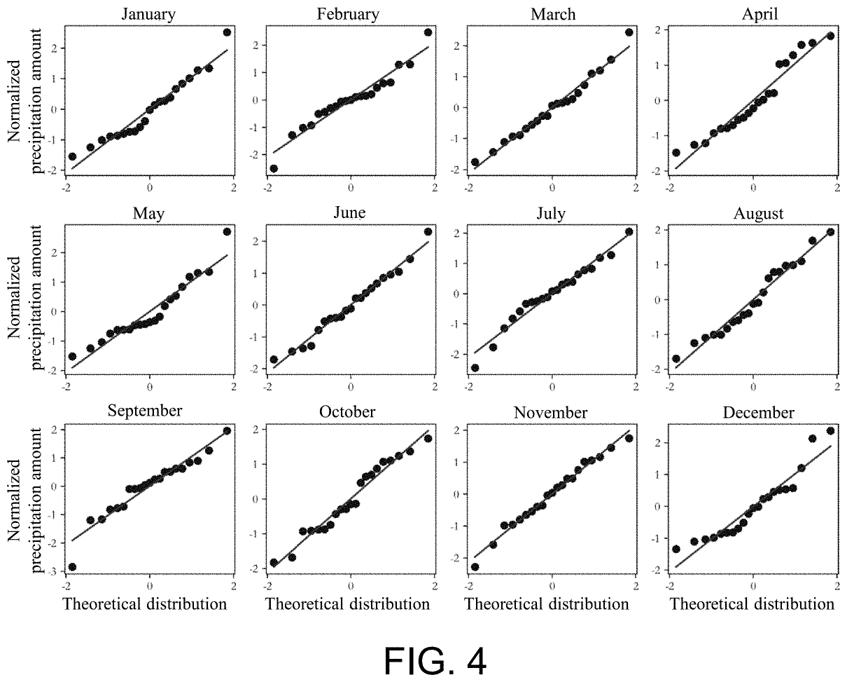

A function stats.norm.ppf is used to transform the cumulative distribution function values into variables obeying a normal distribution according to the calculated cumulative distribution function values, so as to normalize the raw forecast data and the observed values; the normalized data are respectively stored in variables trans_x and trans_y, facilitating subsequent modeling. Furthermore, a function pyplot in the Matplotlib and a function stats.proplot in the Scipy are used to draw the quantile-quantile plot of the observed precipitation values before and after the transformation to verify the normality thereof, as shown in FIGS. 3 and 4 which are respectively quantile-quantile plot of the observed precipitation values before and after the transform.

A joint normal distribution model is constructed; a correlation coefficient between the transformed forecast data variable trans_x and the observed value variable trans_y is calculated by means of a function stats.pearson, so as to characterize the correlation therebetween.

Conditional probability distribution parameters of the observed values, namely the mean and the standard deviation sigma, are calculated; the mean and the sigma are inputted into a function stats.norm.rvs as parameters to perform random sampling, so as to obtain 1000 samples.

The cumulative distribution function values of the 1000 randomly sampled samples in the standard normal distribution are calculated; and finally the samples are inversely transformed according to the Gamma distribution parameter para_y to obtain a calibrated forecast result.

For the forecast in each month, the raw forecast data is calibrated according to the above steps, and finally a group of calibrated forecast results of the month are obtained. The forecast data of 12 months are sequentially calibrated to obtain 12 groups of calibrated forecast results. And the 12 groups of raw forecast data and the calibrated forecast results are put together to perform forecast verification.

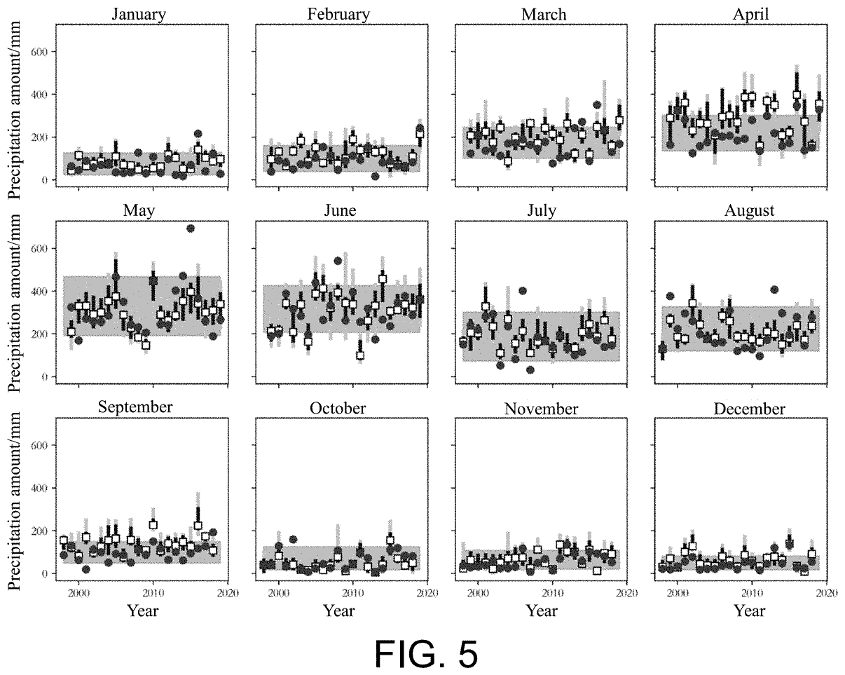

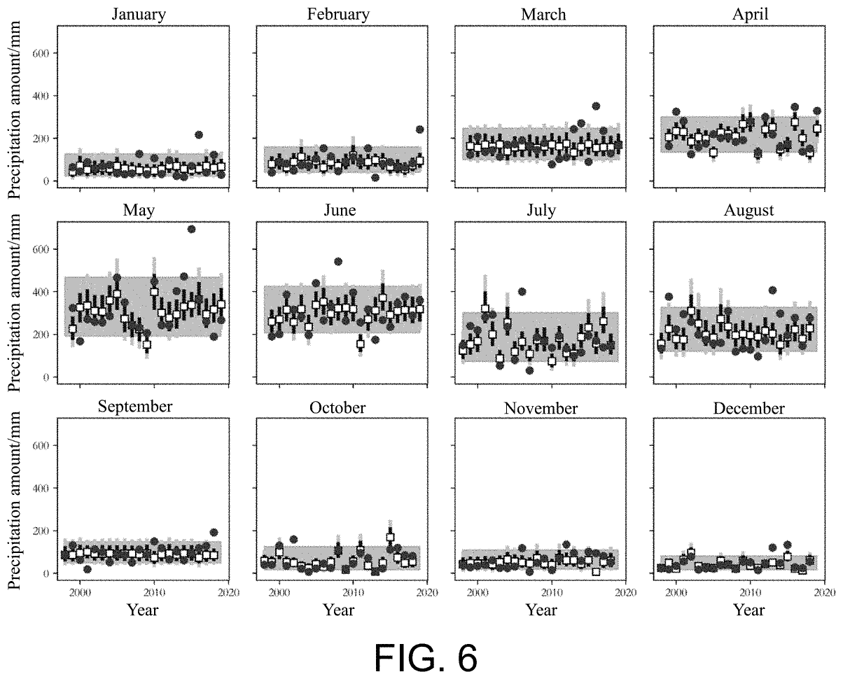

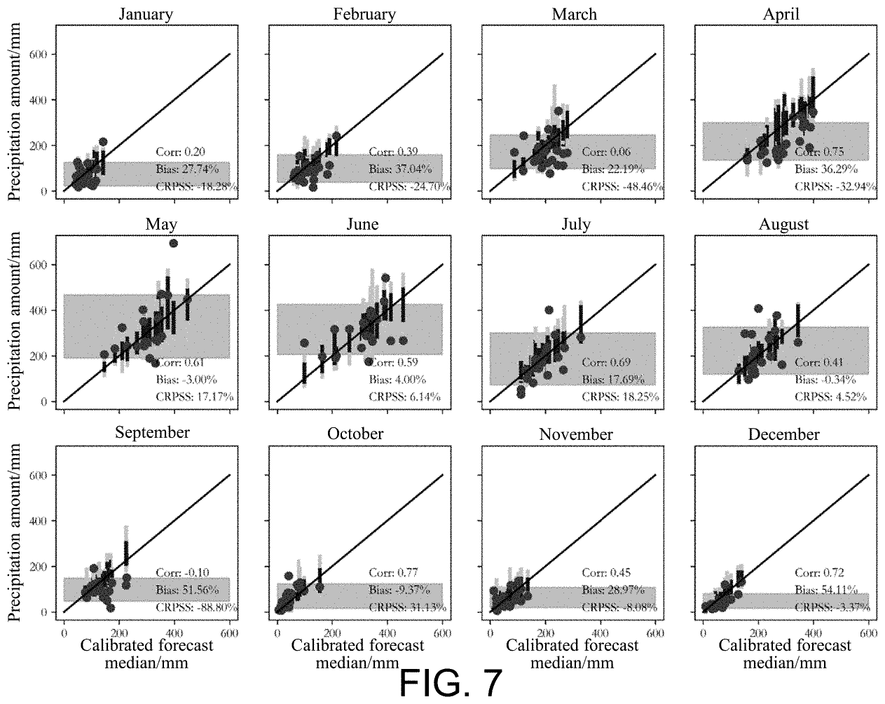

Specifically, a percentile function in Numpy is used to respectively calculate the quantiles 10, 25, 50, 75, and 90 of the raw forecast and the calibrated forecast; and a function pyplot.plot in Matplotlib is used to draw precipitation forecast time series diagrams by taking year as the x-axis and the precipitation amount as the y-axis, as shown in FIG. 5 and FIG. 6 which are respectively the time series diagrams of the raw forecast data and the calibrated forecast according to the present embodiment. Then, functions mean and sum in the Numpy are used to calculate the biases and the forecast skill CRPSS of the raw forecast and the calibrated forecast; furthermore, the function pyplot.plot in the Matplotlib is used to draw a forecast diagnostic diagram by taking ensemble forecast medians as the x axis and taking the precipitation forecast distribution interval and the observed values as the y axis; a function pyplot.text is used to interpolate the bias and the forecast skill calculation results in the diagram as shown in FIGS. 6 and 7 which are respectively a diagnostic diagram of the raw forecast and a diagnostic diagram of the calibrated forecast according to the present embodiment.

In FIG. 7, the biases of the raw forecast from January to December are respectively 27.74%, 37.04%, 22.19%, 36.29%, −3.00%, 4.00%, 17.69%, −0.34%, 51.56%, −9.37%, 28.97%, and 54.11%; and the forecast skills CRPSS of the raw forecast from January to December are respectively −18.28%, −24.7%, −48.46%, −32.94%, 17.17%, 6.14%, 18.25%, 4.52%, −88.80%, 31.13%, −8.08%, and −3.37%.

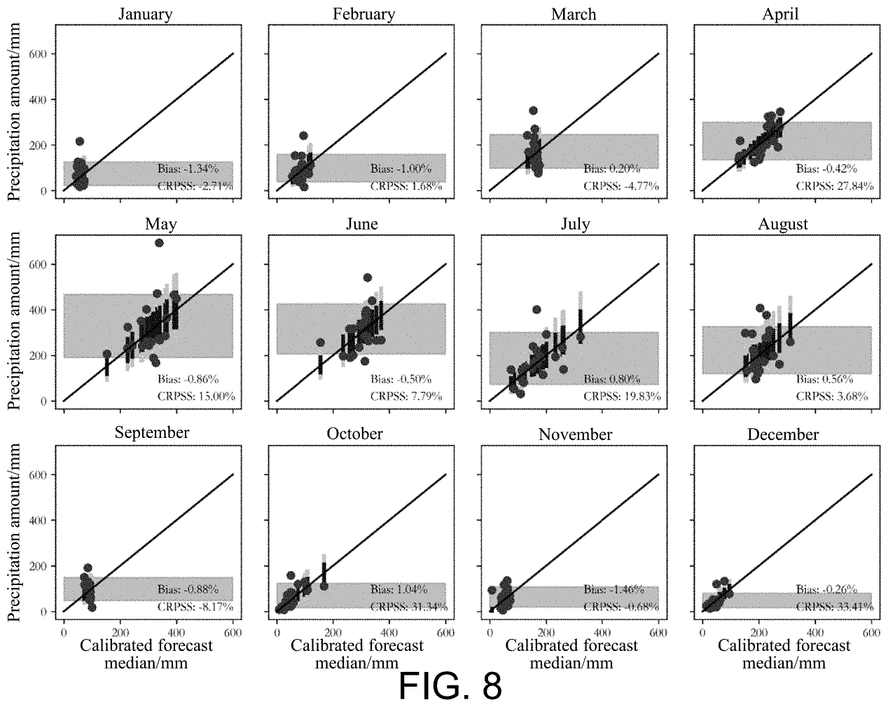

In FIG. 8, the biases of the calibrated forecast from January to December are respectively −1.34%, −1.00%, 0.20%, −0.42%, −0.86%, −0.50%, 0.80%, 0.56%, −0.88%, 1.04%, −1.46%, and −0.26%; and

The forecast skills CRPSS of the calibrated forecast from January to December are respectively −2.71%, 1.68%, −4.77%, 27.84%, 15.00%, 7.79%, 19.83%, 3.68%, −8.17%, 31.34%, −0.68%, and 33.41%.

By comparing the above biases and the forecast skills CRPSS, it can be seen that after the method for calibrating monthly precipitation forecast by using a Gamma-Gaussian distribution is used, it is obvious that the biases of the calibrated forecast result are effectively reduced than that of the raw forecast data; the biases in the calibrated forecast are basically within 1.5%, and the forecast skill CRPSS thereof are more stable.

In addition, the present embodiment can use the sentences class ( ) and def ( ) in the Python to encapsulate each step of the precipitation forecast calibration to form class functions which are respectively gamma_fit, trans_norm, back_trans, conditional_distribution, and gamma_gaussian; the class functions are stored in a .py file; when in use, the precipitation forecast in a basin can be calibrated only by calling the class functions by means of an import sentence.

The same or similar reference signs correspond to the same or similar components.

The words for describing position relationships in the drawings are used for illustrative purpose only, but should not be considered as a limitation to the present patent.

It is obvious that the above embodiments of the present invention are only examples for clearly illustrating the present invention, but not limitations to the embodiments of the present invention. A person skilled in the art may make various modifications or variations in other forms on the basis of the above description. It is unnecessary and impossible to exhaust all the embodiments herein. Any modifications, equivalent substitutions, improvements and the like made within the spirit and principles of the present invention are all intended to be concluded in the scope of protection of the claims of the present invention.

What is claimed is:

1. A method for calibrating monthly precipitation forecast by using a Gamma-Gaussian distribution, comprising the following steps:
S1, acquiring forecast data of a monthly average precipitation in a watershed area and corresponding observed values of the average precipitation in the watershed area as input data;
S2, performing fitting on the input data by means of a Gamma distribution function;
S3, calculating a cumulative distribution function value of each input data in a corresponding Gamma distribution;
S4, transforming the cumulative distribution function values into variables obeying a standard normal distribution;
S5, constructing a joint normal distribution according to the variables obeying the standard normal distribution to characterize a correlation between the forecast data and the observed values in the input data; and
S6, randomly sampling the observed values according to the correlation, and inversely transforming acquired samples to obtain a calibrated forecast result.

2. The method for calibrating monthly precipitation forecast by using the Gamma-Gaussian distribution according to claim 1, wherein in the step S2, the Gamma distribution function is used to perform fitting on the forecast data and the observed values respectively to obtain marginal distributions of raw forecast data and the observed values; the expression formula thereof is as follows:
$$\{ \begin{matrix}F \sim G ( {α}_{f} , {β}_{f} ) \\ O \sim G ( {α}_{o} , {β}_{o} )\end{matrix}$$
wherein F denotes a set of K acquired forecast data [f₁, f₂, . . . , f_{K}]; O denotes a set of K acquired observed values [o₁, o₂, . . . , o_{K}]; G(⋅) denotes the Gamma distribution function; α_{f} and β_{f} denote Gamma distribution parameters of the forecast data obtained by means of fitting; and αₒ and βₒ denote Gamma distribution parameters of the observed values obtained by means of fitting.

3. The method for calibrating monthly precipitation forecast by using the Gamma-Gaussian distribution according to claim 2, wherein the Gamma distribution parameters α_{f}, β_{f}, αₒ, and βₒ are respectively calculated with a maximum likelihood estimation method.

4. The method for calibrating monthly precipitation forecast by using the Gamma-Gaussian distribution according to claim 2, wherein in the step S3, a cumulative distribution function in the corresponding Gamma distribution is used to calculate the cumulative distribution function values of each forecast data fᵢ and of each observed value oᵢ in the corresponding Gamma distribution; the expression formula thereof is as follows:
$$\{ \begin{matrix}{P}_{{f}_{i}} = {CDF}_{( {α}_{F} , {β}_{F} )} ( {f}_{i} ) \\ {P}_{{o}_{i}} = {CDF}_{( {α}_{O} , {β}_{O} )} ( {o}_{i} )\end{matrix}$$
wherein P_{f}_{ᵢ} and Pₒ_{ᵢ} respectively denote the cumulative distribution function values corresponding to the forecast data fᵢ and the observed values oᵢ in an i-th year; and CDF_{(α}_{_{F}}_{,β}_{_{F}}₎(fᵢ) and CDF_{(α}_{ₒ}_{,β}_{ₒ}₎(oᵢ) respectively denote the cumulative distribution functions in the Gamma distribution obtained by performing fitting on the forecast data fᵢ and the observed values oᵢ.

5. The method for calibrating monthly precipitation forecast by using the Gamma-Gaussian distribution according to claim 4, wherein in the step S4, the cumulative distribution function values are regarded as quantiles of the standard normal distribution; the cumulative distribution function values are transformed into variables obeying the standard normal distribution by means of an inverse function of the cumulative distribution function in the standard normal distribution; and the expression formula thereof is as follows:
$$\{ \begin{matrix}{\hat{f}}_{i} = {PPF}_{N ( 0 , {1}^{2} )} ( {P}_{{f}_{i}} ) \\ {\hat{o}}_{i} = {PPF}_{N ( 0 , {1}^{2} )} ( {P}_{{o}_{i}} )\end{matrix}$$
wherein PPF_{N(0,1}_{²⁾}(⋅) denotes the inverse function of the cumulative distribution function in the standard normal distribution; and \hat{f}ᵢ and ôᵢ are respectively the forecast data and the observed values obtained by means of normal quantile transform, the transformed forecast data \hat{F}=[\hat{f}₁, \hat{f}₂, . . . , \hat{f}_{K}] and the transformed observed values Ô=[ô₁, ô₂, . . . ,ô_{K}] all obey normal distributions, and the expression formula thereof is as follows:
$$\{ \begin{matrix}\hat{F} \sim N ( 0 , {1}^{2} ) \\ \hat{O} \sim N ( 0 , {1}^{2} )\end{matrix}$$
wherein N(0,1²) denotes the standard normal distribution.

6. The method for calibrating monthly precipitation forecast by using the Gamma-Gaussian distribution according to claim 5, wherein in the step S5, a joint normal distribution is constructed according to the variables \hat{F} and Ô obeying the standard normal distribution to characterize the correlation between the forecast data and the observed values in the input data; and the expression formula thereof is as follows:
$$[ \begin{matrix}\hat{F} \\ \hat{O}\end{matrix} ] \sim N ( [ \begin{matrix}0 \\ 0\end{matrix} ] , [ \begin{matrix}1 & ρ \\ ρ & 1\end{matrix} ] )$$
wherein ρ denotes the correlation between the variables \hat{F} and Ô.

7. The method for calibrating monthly precipitation forecast by using the Gamma-Gaussian distribution according to claim 6, wherein in the step S6, the specific steps are as follows:
S6.1, taking the forecast data \hat{f} as a predictor, taking the observed value ô corresponding to each forecast data as a predictand, and calculating a conditional probability distribution of the predictand, wherein a calculation formula is as follows:
ô|\hat{f}˜N(ρ\hat{f},1−ρ²);
S6.2, randomly sampling a conditional probability distribution result of the observed value ô, and inversely transforming sampled samples according to the cumulative distribution function in the standard normal distribution and the inverse function of the cumulative distribution function in the Gamma distribution obtained by performing fitting on the observed value, so as to obtain a calibrated forecast result.

8. The method for calibrating monthly precipitation forecast by using the Gamma-Gaussian distribution according to claim 1, further comprises the following step: calculating a bias value and a forecast skill according to the calibrated forecast result as forecast verification metrics.

9. The method for calibrating monthly precipitation forecast by using the Gamma-Gaussian distribution according to claim 8, further comprises the following step: drawing a forecast diagnostic diagram according to the calibrated forecast result, the bias value, and the forecast skill.

10. The method for calibrating monthly precipitation forecast by using the Gamma-Gaussian distribution according to claim 9, wherein in the forecast diagnostic diagram, a calibrated forecast median is used as an x axis; a precipitation forecast distribution interval and the observed values are used as a y axis; and calculation results of the bias value and the forecast skill are interpolated in the forecast diagnostic diagram for display.

11. The method for calibrating monthly precipitation forecast by using the Gamma-Gaussian distribution according to claim 2, further comprises the following step: calculating a bias value and a forecast skill according to the calibrated forecast result as forecast verification metrics.

12. The method for calibrating monthly precipitation forecast by using the Gamma-Gaussian distribution according to claim 3, further comprises the following step: calculating a bias value and a forecast skill according to the calibrated forecast result as forecast verification metrics.

13. The method for calibrating monthly precipitation forecast by using the Gamma-Gaussian distribution according to claim 4, further comprises the following step: calculating a bias value and a forecast skill according to the calibrated forecast result as forecast verification metrics.

14. The method for calibrating monthly precipitation forecast by using the Gamma-Gaussian distribution according to claim 5, further comprises the following step: calculating a bias value and a forecast skill according to the calibrated forecast result as forecast verification metrics.

15. The method for calibrating monthly precipitation forecast by using the Gamma-Gaussian distribution according to claim 6, further comprises the following step: calculating a bias value and a forecast skill according to the calibrated forecast result as forecast verification metrics.

16. The method for calibrating monthly precipitation forecast by using the Gamma-Gaussian distribution according to claim 7, further comprises the following step: calculating a bias value and a forecast skill according to the calibrated forecast result as forecast verification metrics.

17. The method for calibrating monthly precipitation forecast by using the Gamma-Gaussian distribution according to claim 11, further comprises the following step: drawing a forecast diagnostic diagram according to the calibrated forecast result, the bias value, and the forecast skill.

18. The method for calibrating monthly precipitation forecast by using the Gamma-Gaussian distribution according to claim 17, wherein in the forecast diagnostic diagram, a calibrated forecast median is used as an x axis; a precipitation forecast distribution interval and the observed values are used as a y axis; and calculation results of the bias value and the forecast skill are interpolated in the forecast diagnostic diagram for display.

19. The method for calibrating monthly precipitation forecast by using the Gamma-Gaussian distribution according to claim 12, further comprises the following step: drawing a forecast diagnostic diagram according to the calibrated forecast result, the bias value, and the forecast skill.

20. The method for calibrating monthly precipitation forecast by using the Gamma-Gaussian distribution according to claim 19, wherein in the forecast diagnostic diagram, a calibrated forecast median is used as an x axis; a precipitation forecast distribution interval and the observed values are used as a y axis; and calculation results of the bias value and the forecast skill are interpolated in the forecast diagnostic diagram for display.
